(19) United States
(12) Patent Application Publication
(10) Pub. No.: US 2009/0300396 A1
(43) Pub. Date: Dec. 3, 2009

(54) INFORMATION PROCESSING APPARATUS

(75) Inventor: Gen WATANABE, Akishima-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/396,226

(22) Filed: Mar. 2, 2009

(30) Foreign Application Priority Data
May 30, 2008 (JP) 2008-143503

(51) Int. Cl. G06F 1/32

(52) U.S. Cl. 713/324

(57) ABSTRACT

According to one embodiment, an information processing apparatus includes a power supply module, a connection bus, a processor connected to the connection bus and including a power supply control circuit module supplied with power from the power supply module and a arithmetic circuit module connected to the power supply control circuit module, a power supply control module configured to control supply of power from the power supply module to the arithmetic circuit module of the processor, and control module for sending, when the power supply control circuit module of the processor receives a predetermined notification, the predetermined notification to the power supply control module from the power supply control circuit module, and controlling, by the power supply control module which has received the predetermined notification, to stop power supply from the power supply module to the arithmetic circuit module.

### CROSS-REFERENCE TO RELATED APPLICATIONS

This application is based upon and claims the benefit of priority from Japanese Patent Application No. 2008-143503, filed May 30, 2008, the entire contents of which are incorporated herein by reference.

### BACKGROUND

1. Field

One embodiment of the present invention relates to a power supply control technique, and more particularly, to an information processing apparatus capable of controlling power supply to unnecessary circuits.

2. Description of the Related Art

In a battery-driven portable computer, it is generally possible to prolong the battery life by reducing the power consumption. When the computer is idle, it is desirable to reduce the power consumption by stopping power supply to unnecessary circuits. For example, Jpn. Pat. Appln. KOKAI Publication No. 4-118711 discloses the following technique. That is, in a computer which includes two CPUs, i.e., a main CPU and a sub-CPU (coprocessor), the main CPU monitors the status of the coprocessor at all times. If it is determined that the coprocessor is unnecessary, the main CPU independently shifts the coprocessor to a power saving mode.

In the technique described in Jpn. Pat. Appln. KOKAI Publication No. 4-118711, since the main CPU independently shifts the coprocessor to a power saving mode, the coprocessor is powered off via a connected connection bus. In this case, the connection bus is powered off. In returning from the power saving mode, therefore, it takes time until the coprocessor becomes usable after powering on the connection bus.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing the outer appearance of an information processing apparatus according to an embodiment of the present invention;

FIG. 2 is an exemplary block diagram showing the main components of the information processing apparatus according to the embodiment;

FIG. 3 is an exemplary block diagram showing the arrangement of a back-end processor of the information processing apparatus according to the embodiment;

FIG. 4 is an exemplary flowchart showing a power supply control method (at the time of shifting to a power saving mode) to which the information processing apparatus according to the embodiment is applied; and

FIG. 5 is an exemplary flowchart showing a power supply control method (at the time of returning from the power saving mode) to which the information processing apparatus according to the embodiment is applied.

### DETAILED DESCRIPTION

Various embodiments according to the invention will be described hereinafter with reference to the accompanying drawings. In general, according to one embodiment of the invention, an information processing apparatus includes: a power supply module; a connection bus; a processor connected to the connection bus and including a power supply control circuit module supplied with power from the power supply module and a arithmetic circuit module connected to the power supply control circuit module; a power supply control module configured to control supply of power from the power supply module to the arithmetic circuit module of the processor; and control module for sending, when the power supply control circuit module of the processor receives a predetermined notification, the predetermined notification to the power supply control module from the power supply control circuit module, and controlling, by the power supply control module which has received the predetermined notification, to stop power supply from the power supply module to the arithmetic circuit module.

An embodiment of the present invention will be described below with reference to the accompanying drawings.

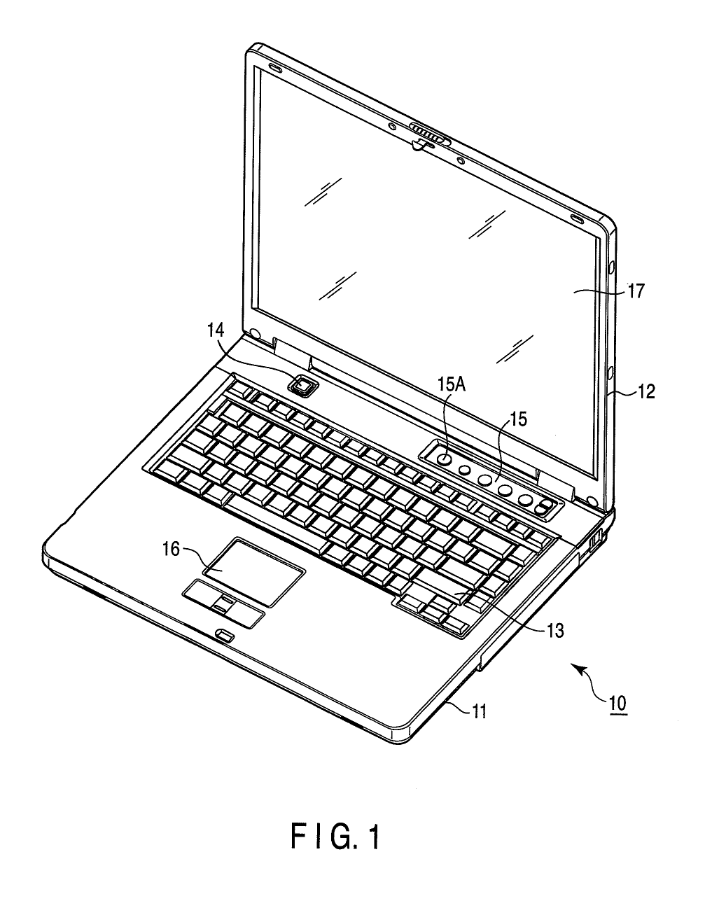

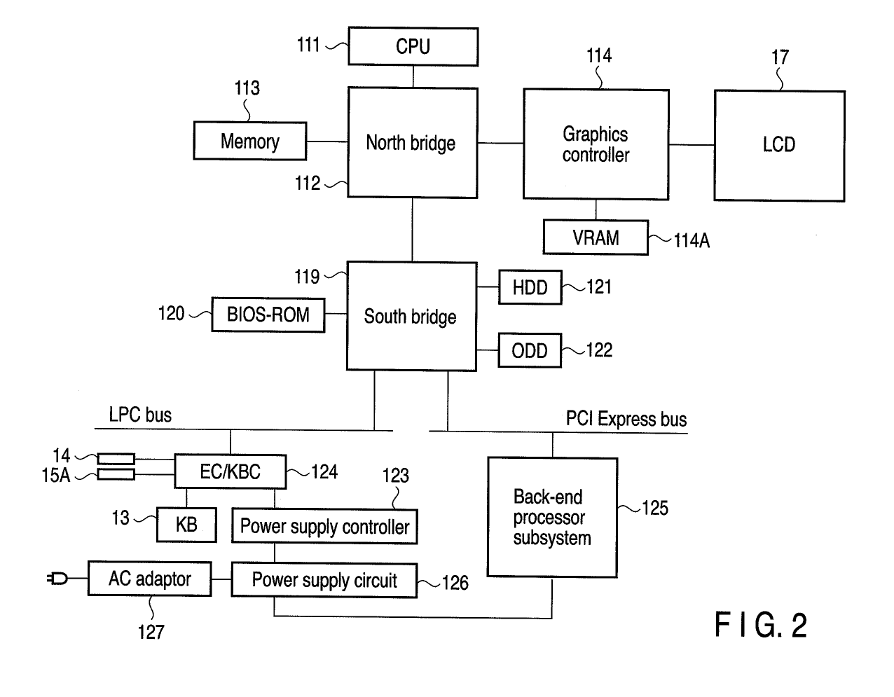

First, the arrangement of an information processing apparatus according to the embodiment of the present invention will be explained with reference to FIGS. 1 and 2. The information processing apparatus is implemented as, e.g., a notebook personal computer 10.

FIG. 1 is a perspective view showing a state in which the display unit of the notebook personal computer 10 is open. The computer 10 includes a computer main body 11 and a display unit 12. The display unit 12 has a built-in display device formed from a liquid crystal display (LCD [display module]) 17. The display screen of the LCD 17 is located almost at the center of the display unit 12.

The display unit 12 is attached to the computer main body 11 to freely pivot between the open position and the closed position. The computer main body 11 has a thin box-shaped housing and includes, on its upper surface, a keyboard 13, a power button 14 to power on/off the computer 10, an input operation panel 15, and a touch pad 16.

The input operation panel 15 is an input device that inputs an event corresponding to a pressed button to a system. The input operation panel 15 has a plurality of buttons to activate a plurality of functions. The buttons include an activation button 15A which activates a predetermined application or the like.

The system configuration of the computer 10 will be described next with reference to FIG. 2.

As shown in FIG. 2, the computer 10 includes a CPU 111, a north bridge 112, a (main) memory 113, a graphics controller 114, the LCD 17, a south bridge 119, a Basic Input/Output System (BIOS)-ROM 120, a hard disk drive (HDD) 121, an embedded controller/keyboard controller IC (EC/KBC) 124, a power supply controller 123, a power supply circuit (power supply module) 126, an AC adaptor 127, and a back-end processor subsystem 125.

The CPU 111 is a main processor for controlling the operation of the computer 10 and executes an operating system (OS) and various application programs, which are loaded from the hard disk drive (HDD) 121 into the main memory 113.

The CPU 111 also executes a system BIOS stored in the BIOS-ROM 120. The system BIOS is a program for hardware control.

The north bridge 112 is a bridge device for connecting the local bus of the CPU 111 to the south bridge 119. The north bridge 112 incorporates a memory controller to control access to the main memory 113. The north bridge 112 also has a function of executing communication with the graphics controller 114 via a PCI Express bus or the like. A video random access memory (VRAM) 114A with a predetermined capacity is connected to the graphics controller 114.

The south bridge 119 controls devices on a Low Pin Count (LPC) bus and devices on a Peripheral Component Interconnect (PCI) Express bus. The south bridge 119 incorporates an Integrated Drive Electronics (IDE) controller to control the HDD 121 and the like. The south bridge 119 also has a function of controlling access to the BIOS-ROM 120 and the like.

The HDD 121 is a storage device for storing various kinds of software and data.

The EC/KBC 124 is a one-chip microcomputer on which an embedded controller for power management and the like are integrated. The EC/KBC 124 has a function of powering on/off the computer 10 as the user operates the power button 14.

The power supply controller 123 controls supply of the power, which is input from the AC adaptor 127 via the power supply circuit 126, to the devices of the computer 10.

The back-end processor subsystem 125 is a sub-processor which operates independently of the CPU 111.

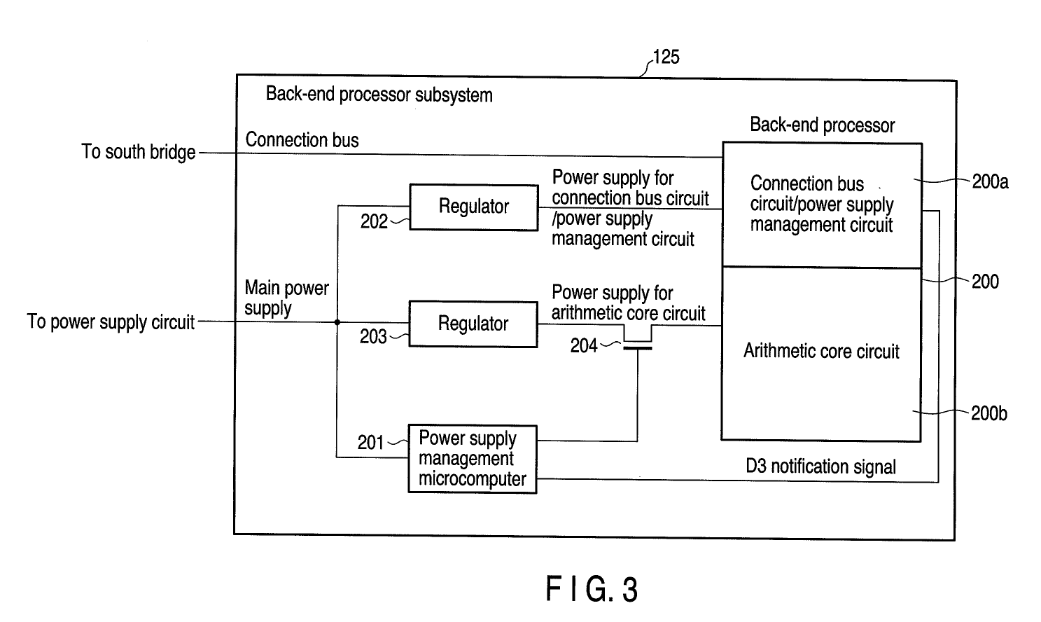

As shown in FIG. 3, the back-end processor subsystem 125 includes a back-end processor (processor) 200, regulators 202 and 203 which manage the power supplied from the power supply circuit 126, a power supply management microcomputer (power supply control module) 201, and a switching module (load switch) 204.

The back-end processor 200 includes a connection bus circuit/power supply management circuit (power supply control circuit module) 200a for a connection bus (e.g., a PCI Express bus) connecting with the south bridge 119, and an arithmetic core circuit (arithmetic circuit module) 200b. The connection bus circuit/power supply management circuit 200a is supplied with power via the regulator 202, and operates with the same power supply. The arithmetic core circuit 200b is supplied with power via the regulator 203. The switching module 204 turns on/off power supply from the power supply management microcomputer 201 to the arithmetic core circuit 200b. The connection bus circuit/power supply management circuit 200a sends, to the power supply management microcomputer 201, a control signal for controlling the turning on/off of power supply to the arithmetic core circuit 200b. When the back-end processor 200 becomes idle (whether the back-end processor 200 is idle is monitored and determined by the CPU 111), the arithmetic core circuit 200b is powered off to stop power supply. The connection bus circuit/power supply management circuit 200a and arithmetic core circuit 200b are configured to be completely separated from each other within the back-end processor 200.

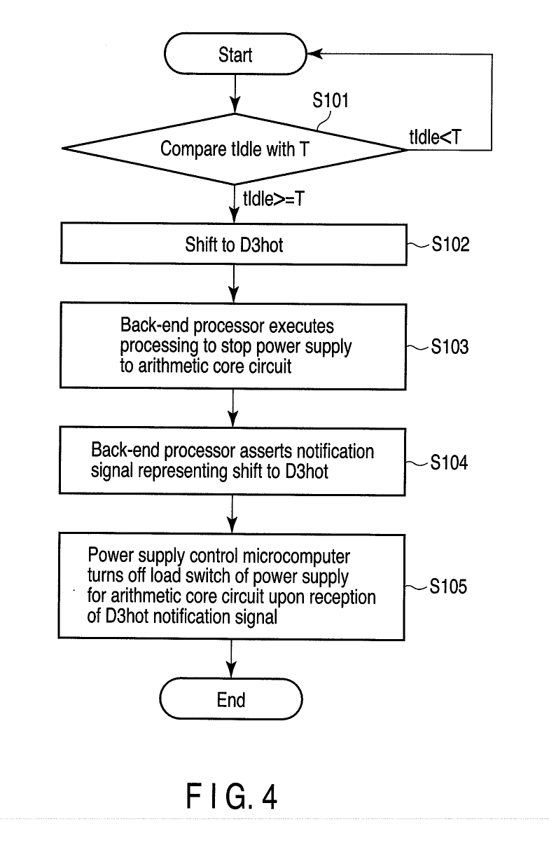

FIG. 4 is a flowchart showing processing when the back-end processor shifts to a power saving mode. Assume that the back-end processor 200 operates in a normal operation state in this case. The normal operation state will be referred to as a D0 state hereinafter. A control driver managed by the CPU 111 controls and monitors the operation of the back-end processor 200.

Upon detecting that the arithmetic core circuit 200b of the back-end processor subsystem 125 has been idle for a certain time (T) or more (tidle≧T in block S101), the control driver of the back-end processor 200 managed by the CPU 111 writes, into a power management control/status register (PMCSR), information (power status bit data) representing a state (to be referred to as a D3hot state hereinafter) in which only the connection bus circuit/power supply management circuit is supplied with power, and the arithmetic core circuit is not operating and can be powered off. The control driver then shifts the back-end processor 200 to a device state D3hot (block S102). When shifting the back-end processor 200 to the D3hot state, the control driver sets the power status bit data to “2h”, and writes it to the power management control/status register (PMCSR).

Note that the PMCSR is provided within the connection bus circuit of the connection bus circuit/power supply management circuit 200a, and is defined in the PCI Bus Power Management Interface Specification. The PMCSR stores the power status bit data by setting from the host side (CPU 111). It is possible to determine the current device state by reading the power status bit data. If, for example, the power status bit data is “0”, the device state is “D0”. If the power status bit data is “2h”, the device state is “D3hot”. Although a case in which the back-end processor 200 shifts to a device state D3hot has been explained, the present invention is not limited to this. The back-end processor 200 may shift to, e.g., an idle state.

Subsequently, the back-end processor 200 executes processing to stop power supply to the arithmetic core circuit 200b (block S103). The connection bus circuit/power supply management circuit 200a of the back-end processor 200 then asserts (sends) a D3hot notification signal (a notification requesting changing the device state of the back-end processor 200 from the D0 state to the D3hot state) to the power supply management microcomputer 201 (block S104). The power supply management microcomputer 201 which has received the D3hot notification signal turns off the switch of the switching module 204 to stop power supply from the regulator 203 to the arithmetic core circuit 200b (block S105).

In the above-described state, although power supply to the arithmetic core circuit 200b of the back-end processor 200 stops, power is supplied to the connection bus circuit/power supply management circuit 200a. That is, power is supplied from the regulator 202 to the connection bus circuit/power supply management circuit 200a. In return processing (e.g., transition of the device state from D3hot to D0) (to be described later), since power is supplied to the connection bus circuit/power supply management circuit 200a, the return processing can be executed within a short time.

In the above embodiment, the control driver of the back-end processor 200 managed by the CPU 111 detects that the arithmetic core circuit 200b of the back-end processor subsystem 125 has been idle for a certain time (T) or more, and then shifts the back-end processor 200 to the device state D3hot. However, upon reception of a notification that a predetermined application operating on the operating system, e.g., a moving image playback application has been suspended, the connection bus circuit/power supply management circuit 200a may send a D3hot notification signal to the power supply management microcomputer 201.

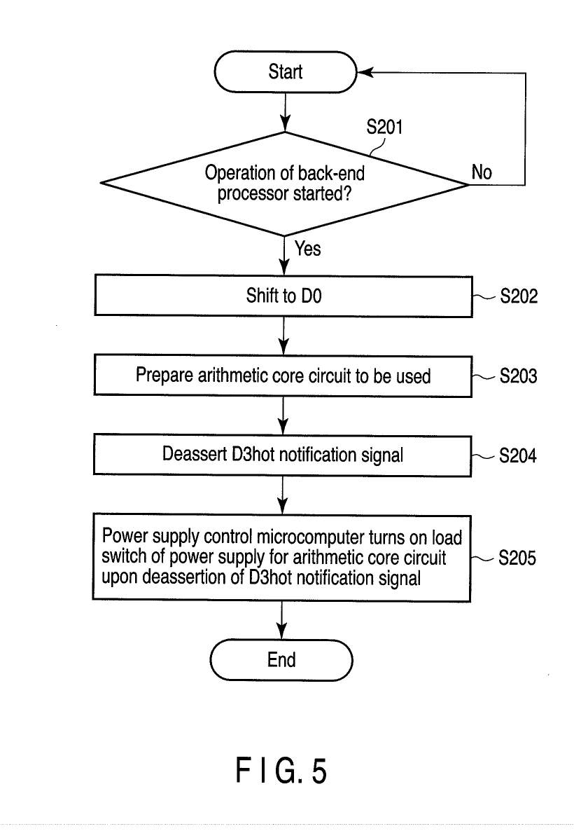

FIG. 5 is a flowchart showing processing when the back-end processor shifts from a power saving mode to a normal operation mode. First, assume that the back-end processor 200 operates in a predetermined state (e.g., a D3hot state) in this case. The control driver controls and monitors the operation of the back-end processor 200.

Upon reception of an operation request (a request for the start of the operation of the back-end processor 200) of the arithmetic core circuit 200b of the back-end processor subsystem 125 (YES in block S201), the control driver of the back-end processor 200 writes the information (power status bit data) representing, e.g., a device state D0 into the power management control/status register (PMCSR) (for example, the control driver writes the power status bit data as “0”), and shifts the back-end processor 200 to a device state D0 (normal operation state) (block S202). The control driver of the back-end processor 200 prepares the arithmetic core circuit 200b of the back-end processor 200 to be used (block S203). The connection bus circuit/power supply management circuit 200a of the back-end processor 200 deasserts the D3hot notification signal to the power supply management microcomputer 201. That is, the connection bus circuit/power supply management circuit 200a sends a disable signal of the above D3hot notification signal (a notification requesting changing the device state of the back-end processor 200 from the predetermined state to the normal operation state) (block S204). The power supply management microcomputer 201 which has received the disable signal of the D3hot notification signal turns on the switch of the switching module 204, and starts power supply from the regulator 203 to the arithmetic core circuit 200b (block S205). A module can be accomplished in software and hardware.

It is an object of the present invention to provide an information processing apparatus capable of shortening the time until a processor becomes usable when the processor shifts from a power saving mode to an in-a use state.

According to the above embodiment, by turning off power supply to the circuits other than the connection bus connected to the back-end processor and shifting the back-end processor to a power saving mode, it is possible to return the back-end processor from the power saving mode within a short time. It is also possible to efficiently reduce the power consumption without changing the hardware architecture of an existing personal computer. Furthermore, the operating system and device driver manage only the transition of the device state. This can realize power savings without introducing an extra mechanism.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a power supply module;
a connection bus;
a processor connected to the connection bus and comprising a power supply control circuit module configured to receive power from the power supply module and an arithmetic circuit module connected to the power supply control circuit module;
a power supply control module configured to control power from the power supply module to the arithmetic circuit module of the processor; and
a controller configured to send a predetermined notification to the power supply control module from the power supply control circuit module, and to control the power supply control module which has received the predetermined notification to stop power supply from the power supply module to the arithmetic circuit module.

2. The apparatus of claim 1, wherein the predetermined notification comprises a request of changing a device state of the processor from a normal operation state to a predetermined state.

3. The apparatus of claim 1, wherein the predetermined notification comprises a notification that a predetermined application on the information processing apparatus has ended.

4. The apparatus of claim 1, wherein the power supply control circuit module of the processor is configured to send to the power supply control module a notification that the processor has entered the normal operation state, and the power supply control module which has received the notification is configured to start power supply from the power supply module to the arithmetic circuit module when the device state of the processor shifts from the predetermined state to the normal operation state.

5. The apparatus of claim 1, wherein the predetermined state is a state in which the information processing apparatus is idle.
